(19) United States
(12) Patent Application Publication
(10) Pub. No.: US 2020/0319940 A1
(43) Pub. Date: Oct. 8, 2020

(54) MANAGEMENT OF DYNAMIC SHARING OF CENTRAL PROCESSING UNITS

(71) Applicant: Telefonaktiebolaget LM Ericsson (publ), Stockholm (SE)

(72) Inventors: Amir ROOZBEH, Kista (SE); Mozhgan MAHLOO, Solna (SE); Joao MONTEIRO SOARES, Solna (SE); Daniel TURULL, Solna (SE)

(73) Assignee: Telefonaktiebolaget LM Ericsson (publ), Stockholm (SE)

(21) Appl. No.: 16/956,265

(22) PCT Filed: Dec. 21, 2017
(86) PCT No.: PCT/SE2017/051328

§ 371 Date: Jun. 19, 2020

(51) Int. Cl. G06F 9/52; G06F 9/50; G06F 9/455

(52) U.S. Cl. CPC G06F 9/52; G06F 9/5077; G06F 2009/45579; G06F 9/5083; G06F 2009/45595; G06F 9/45558

(57) ABSTRACT

It is disclosed a resource sharing manager, RSM, operative to provide efficient utilization of central processing units, CPUs, within virtual servers. The RSM dynamically obtains (102) information about which CPUs are sharable to which virtual servers, (104) information about that one or more of said sharable CPUs are available, and (106) information about that one or more virtual servers of said virtual servers require more processing resources. It also dynamically assigns (108) a first CPU of said one or more sharable CPUs when available, to a first virtual server of said one or more virtual servers. This enables the first virtual server of said one or more virtual servers, to use the first CPU, until the RSM receives information that the first CPU no longer is sharable to, or needed by, the first virtual server. Overhead is reduced by circumventing a hypervisor when sharing CPUs in virtual servers.

### TECHNICAL FIELD

This disclosure relates to sharing of central processing units (CPUs). More particularly, it relates to a method, a resource sharing management and a computer program for providing efficient utilization of a plurality of CPUs.

### BACKGROUND

A key challenge in data centers (DCs) of today is low resource utilization, as resources that the DC operator pays for are not utilized to their full capacity. DC providers can employ advanced resource scheduling techniques along with container virtualization technology to implement server consolidation, multi-tenant cloud, efficient resource sharing, and improve DC resource utilization, while reducing their costs and provide dynamic scaling to their customers.

Data centers traditionally comprise a number of servers wherein each server contains a single motherboard that may be integrated with various resources.

FIG. 1 schematically presents such various resources in the form of processing units, such as central processing unit (CPU) cores; memory units such as random access memory (RAM) units; networking, such as a network interface card (NIC); and storage units, handled by an input/output handler. The resources are herein interfaced to a DC network (NVV) via the NIC.

In order to provide resource sharing and increase of resource utilization data center providers may employ computer virtualization.

Computer virtualization is a technique that abstracts different hardware parts of a computer platform and allows execution of different operating systems.

There are several ways of virtualizing a computational system, where a commonly used way is the one that uses a virtual machine monitor (VMM), sometimes also called hypervisor. The hypervisor may be considered to be a layer of software that provides to a virtual machine the illusion that it is running its own resources. By using such means, multiple operating systems and applications can run on the same server while sharing resources of one and the same physical server.

However, virtualization comes at a cost, i.e., extra overhead, as it interleaves execution of the applications and the execution of the hypervisor/host operative system (OS).

A disaggregated DC is an alternative architecture to traditional DC. In the disaggregated architecture, the DC is composed of a collection of disaggregated resources. In this architecture, DC resources, i.e., compute, memory, storage, and network interface card (NIC), are typically realized as independent modular components. Resource allocation within the disaggregated DC is based on allocations of each of the different resource types, being for instance compute, memory, storage, and networking, from their respective resource pool. A disaggregated architecture allows dynamic composition of logical servers, such as motherboards, by selecting and configuring resources that may be physical, as needed from different resource pools and interconnecting them through an interconnection fabric.

FIG. 2 schematically illustrates system blocks of a disaggregated computational architecture. Each host 200 runs a host operative system (OS) 201 on its own for the computational instances 202, 203, 204.

Via a fast interconnect 206 various resources are provided to individual virtual motherboards 205. Computational resources are comprised of multiple CPU pools 210, where each CPU pool comprises multiple CPUs 211.

Similarly the resources comprise one or more memory pool 220, each having a multiple of memory units or memories 221. Also, the resources also comprise one or more storage pools 230, each having one or more disks 231.

Portions of each CPU pool, memory pool and storage pool are thus assigned to individual hosts via the virtual motherboards. The virtual motherboards have assigned resources from different resource pools.

Each host 200 can use the resources assigned to each virtual motherboard. The host OS 201 can also employ virtualization technologies if applicable.

On top of the host OS, the computational instances 202, 203, 204 can execute applications. The computational instance can be virtual containers, virtual machines (VMs) or any other executable code.

The disaggregated DC's architecture differs in a number of aspects as compared to traditional DC architecture.

It has been noted that resource utilization among different logical servers can be low. There is hence a need to improve resource utilization among logical servers.

### SUMMARY

It is an object of exemplary embodiments herein to address at least some of the issues outlined above and to efficiently utilize a processing arrangement. This object and others are achieved by a resource sharing manager, a method performed therein, a computer program and computer-readable storage medium, according to the appended independent claims, and by the exemplary embodiments according to the dependent claims.

According to an aspect, the exemplary embodiments provide a method of efficient utilization of a plurality of central processing units, within two or more virtual servers. The method is performed in a resource sharing manager that is adapted to manage sharing of said plurality of central processing units within said two or more virtual servers, by interacting with said plurality of central processing units and the two or more virtual servers. The method comprising dynamically obtaining information about which central processing units are sharable to which virtual servers. The method also comprises dynamically obtaining information about that one or more of said sharable central processing units are available. The method also comprises dynamically obtaining information about that one or more virtual servers of said two or more virtual servers require more processing resources. In addition, the method comprises dynamically assigning a first central processing unit of said one or more sharable central processing units being available, to a first virtual server of said one or more virtual servers requiring more resources, based on which central processing units are sharable to which virtual server. This enables the first virtual server of said one or more virtual servers to which the first central processing unit is assigned, to use the first central processing unit, until receiving information that the first central processing unit no longer is sharable to, or needed by, the first virtual server.

According to another aspect, the exemplary embodiments provide a resource sharing manager that is operative to provide efficient utilization of a plurality of central processing units within two or more virtual servers. The resource sharing manager is adapted to dynamically obtain information about which central processing units are sharable to which virtual servers, and to dynamically obtain information about that one or more of said sharable central processing units are available. The resource sharing manager is also operative to dynamically obtain information about that one or more of said two or more virtual servers require more processing resources. The resource sharing manager is further also adapted to assign a first central processing unit of said one or more sharable central processing units being available, to a first virtual server of said one or more virtual servers requiring more resources, based on which central processing units are sharable to which virtual server, enabling the first virtual server of said one or more virtual servers to which said central processing unit is assigned, to use the first central processing unit, until the resource sharing manager that is adapted to receive information that the first central processing unit no longer is sharable to, or needed by, the first virtual server, receives such information.

According to another aspect, the exemplary embodiments provide a resource sharing manager that is operative to provide efficient utilization of a plurality of central processing units, within two or more virtual servers. The resource sharing manager comprises an interface and a controller that is connected to the interface. The interface is adapted to dynamically obtain information about which central processing units are sharable to which virtual servers, and to dynamically obtain information about that one or more of said sharable central processing units are available. The interface is also adapted to dynamically obtain information about that one or more of said two or more virtual servers require more processing resources. The controller is adapted to assign a first central processing unit of said one or more sharable central processing units being available, to a first virtual server of said one or more virtual servers requiring more resources, based on which central processing units are sharable to which virtual server, enabling the first virtual server of said one or more virtual servers to which the first central processing unit is assigned, to use the first central processing unit, until the resource sharing manager that is adapted to receive information that the first central processing unit no longer is sharable to, or needed by, the first virtual server, receives such information.

According to yet another aspect, the exemplary embodiments provide a resource sharing manager that is operative to provide efficient utilization of a plurality of central processing units, within two or more virtual servers. The resource sharing manager comprises a processing circuit and a memory. The memory has instructions being executable by the processing circuit, wherein said processing circuit when executing said instructions is configured to dynamically obtain information about which central processing units are sharable to which virtual servers. The processing circuit, when executing said instructions, is also configured to dynamically obtain information about that one or more of said sharable central processing units are available. The processing circuit, when executing said instructions, is also configured to dynamically obtain information about that one or more of said two or more virtual servers require more processing resources. In addition, the processing circuit is, when executing said instructions, also configured to assign a first central processing unit of said one or more sharable central processing units being available, to a first virtual server of said one or more virtual servers requiring more resources, based on which central processing units are sharable to which virtual server. This enables the first virtual server of said one or more virtual servers to which the first central processing unit is assigned, to use the first central processing unit, until the processing circuit that is adapted to receive information that the first central processing unit no longer is sharable to, or needed by, the first virtual server, receives such information.

Exemplary embodiments of this disclosure present the following advantages:

It is an advantage that an improved CPU utilization is achieved by reducing overhead due to passing through extra management layer (hypervisor) when sharing CPUs within different instances or virtual servers.

Virtual servers can have full control over their dynamically allocated resources (CPUs) during the time slot that is given to them, which increase security, and prevent different instances, which could time-share CPU starve or impact each other's performance.

Subsequent to setting up connections between the resource sharing manager and central processing units, communication may be performed directly via an OS, i.e. without having to pass a hypervisor layer, which would else cause an unnecessary latency.

The present disclose enables virtual servers, or instances, to allocate a guaranteed amount of resources, without being charged for all, since resources can be shared when not being used.

### BRIEF DESCRIPTION OF THE DRAWINGS

Embodiments will now be described in more detail, and with reference to the accompanying drawings, in which:

FIG. 1 schematically illustrates a traditional server having various resources;

FIG. 2 schematically illustrates system blocks of hardware disaggregated architecture;

FIG. 3 presents DC interactions related to the present disclosure;

FIG. 4 presents a hardware management system, related to resource sharing management, according to some embodiment of the present disclosure;

FIGS. 5 to 9 schematically present examples of resource allocation, related to embodiments of the present disclosure;

FIG. 10 presents a flow chart of actions in a method of efficient utilization of a plurality of central processing units (CPUs), according to embodiments of the present disclosure;

FIGS. 11 and 12 present schematically present a resource sharing manager according to different embodiments of the present disclosure.

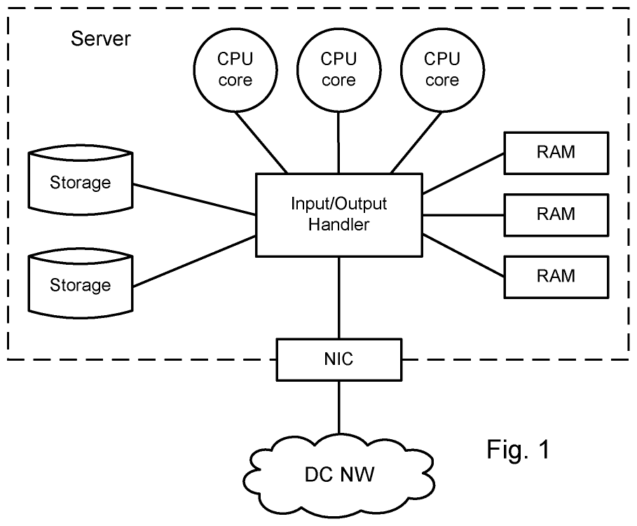

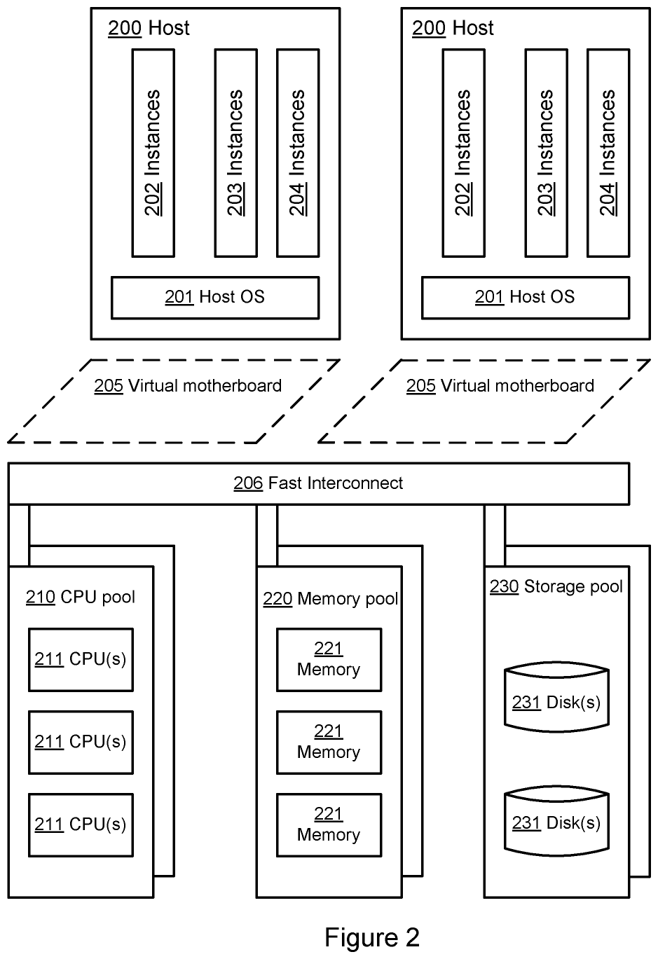

### DETAILED DESCRIPTION

In the following description, exemplary embodiments will be described in more detail, with reference to accompanying drawings. For the purpose of explanation and not limitation, specific details are set forth, such as particular examples and techniques in order to provide a thorough understanding.

As indicated above, resource sharing in existing model is based on hypervisors that introduce additional cost.

Resource sharing for CPU is in practice limited to the CPU resources present within a server. As a result a server cannot use CPU resources from other servers in the DC on demand.

The present disclosure provides a method and a resource sharing manager for implementing a CPU time sharing mechanism rather than using hypervisor-based resource sharing, by dividing CPU resources into sharable states and dedicated states.

Advantages which will become apparent from the description comprise an improved CPU utilization by reducing overhead due to passing through extra management layer (hypervisor) when sharing CPUs within different instances or virtual servers.

Virtual servers can have full control over their dynamically allocated resources (CPUs) during the time slot that is given to them, which increase security, and prevent different instances, which could time-share CPU starve or impact each other's performance.

Subsequent to setting up connections between the resource sharing manager and central processing units, communication may be performed directly via an OS, i.e. without having to pass a hypervisor layer, which would else cause an unnecessary latency.

The present disclose enables virtual servers, or instances, to allocate a guaranteed amount of resources, without being charged for all, since resources can be shared when not being used.

The solution proposed herein introduces an inventive approach to providing a compute resource sharing from a data center (DC) using hardware resource disaggregation architecture.

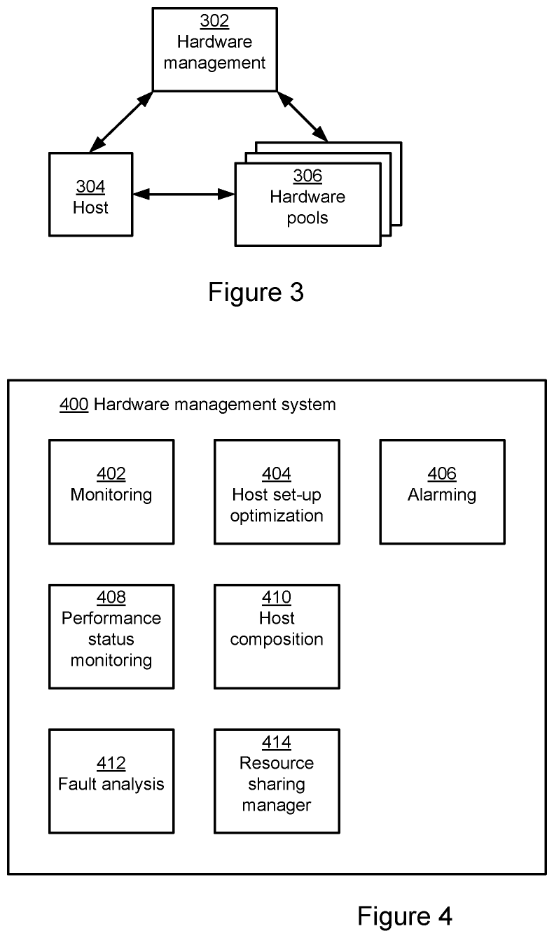

FIG. 3 presents DC interactions related to the present disclosure. The hardware management 302 is responsible for an entire lifecycle management of the DC infrastructure, including operations such as: virtual motherboard composition, including creation, scale up/down, and termination, to mention a few tasks, by interaction with hardware (HW) pools 306. The hardware management 302 is also responsible for the resource sharing manager (RSM), fault detection and prevention, and host setup performance optimization, by interaction with the Host 304.

FIG. 4 schematically presents a hardware management system 400 with a subset of the internal functionalities/services. The hardware management system 400 comprises: monitoring 402, host set-up optimization 404, alarming 406, performance status monitoring 408, host composition 410, fault analysis 412, and resource sharing management 414.

The functionalities included in this disclosure reside in the resource sharing manager (RSM) 414. It is noted that the RSM 414 may be part of a hardware management system 400, but may alternatively be a stand-alone component.

The RSM may be responsible for dynamically maintaining information about a mapping between instances, or virtual servers, and their CPUs. CPUs may have various sharable states; such as not assigned (or NULL), i.e. not belonging to any virtual server; dedicated, i.e. not sharable, even if not being used and; sharable, i.e. owned by a virtual server but shared to another when not being used.

The information dynamically maintained by RSM is not limited to the above and may be extended by more information, such as shared time window, priority level, etc.

The CPU resources in either the sharable state “not assigned” and “sharable” typically notices the resource sharing manager that they are available when not being used.

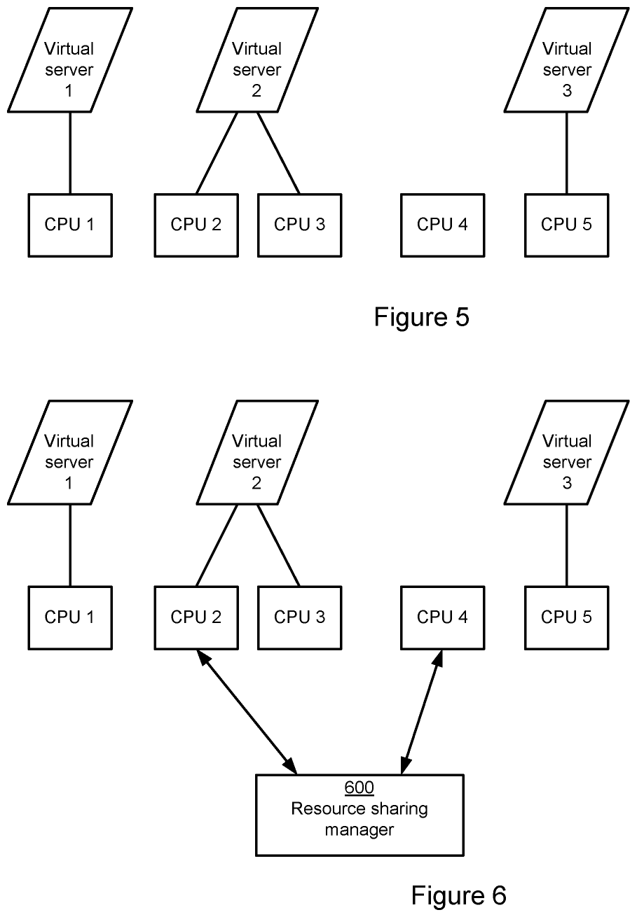

FIG. 5 schematically presents an example of initial resource allocation of compute pool, related to embodiments of the present disclosure. The compute pool comprises five CPUs, CPU 1, CPU 2, CPU 3, CPU 4 and CPU 5. It is noted that each CPU may comprise one or more CPU cores. From these five CPUs, three virtual servers are composed. Virtual server 1 has, or owns, CPU 1, virtual server 2 has CPU 2 and CPU 3, and virtual server 3 has CPU 5. It is noted that CPU 4 is not assigned to any virtual server.

As CPU 4 is not assigned to any virtual server, the resource sharing manager can decide to assign this resource, i.e. share CPU 4 to any virtual server in need of extra compute resources. The information about the status of each CPU may be provided from each CPU by registration. Alternatively, this information may be obtained by the RSM from monitoring the usage of each CPU.

The CPU resources in FIG. 5 may be understood as being in the following sharable states: CPU 1 being in dedicated state; CPU 2 being in sharable state; CPU 3 being in dedicated state; CPU4 being in not assigned state; and CPU 5 in dedicated state.

FIG. 6 schematically presents a continuation of the example presented in FIG. 5, of initial resource allocation of compute pool, related to embodiments of the present disclosure. FIG. 6 presents a resource sharing manager 600, being adapted to provide efficient utilization of a plurality of CPUs.

CPU 2 is thus in sharable state, i.e. that CPU 2 is owned by a virtual server, here virtual server 2, but may be shared to another virtual server when not being used. The CPU 2 may thus register to the RSM 600, or RSM 600 may obtain information about the state of the CPU 2 from monitoring. Dynamic registration is performed when there is no or low load of the CPU in question. The load may be communicated also to the RSM, alternatively the RSM may detect that the CPU has not been used for a while. FIG. 6 thus presents interactions such as potential registrations by CPU 4 and by CPU 2 with RSM 600.

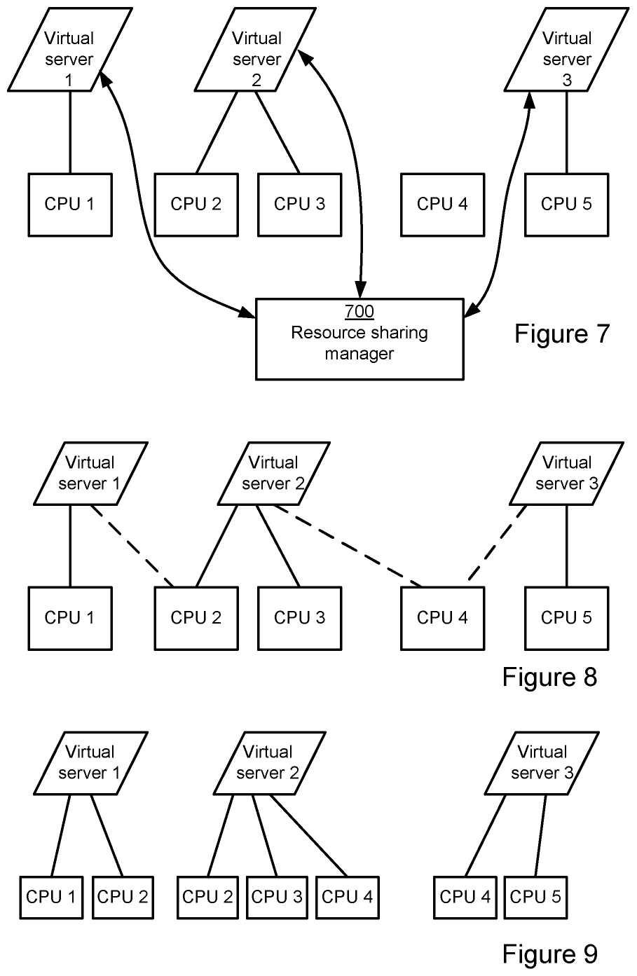

FIG. 7 schematically presents a possible continuation of the example presented in FIG. 6, of resource allocation of compute pool, related to embodiments of the present disclosure.

It is further noted that meanwhile, virtual servers may also register themselves with the RSM. Virtual server 1, virtual server 2, as well as virtual sever 3 registers herein with the RSM 700, thereby requesting more resources. Hence, all virtual resources here request more processing resources.

Knowing that CPU 1, CPU 3 and CPU 5 are in dedicated state, i.e. they cannot be shared, even when not being used, the only resources that can be assigned, or allocated, by the RSM are, in this example, CPU 2 and CPU 4.

The RSM 700 may assign CPU 2 to virtual server 1 as secondary or a stand-by, i.e. to be assigned to virtual server 1 when CPU 2 is not being used. While CPU 2 is used, its resources are allocated by virtual server 2, as it is owned by said virtual server.

The RSM 70 may also assign CPU 4 with virtual server 2 and virtual server 3, as both these virtual servers requested more processing resources. The CPU 4 is herein assigned as secondary (to be explained below).

FIG. 8 schematically presents a continuation of the example presented in FIG. 7, of resource allocation of compute pool, related to embodiments of the present disclosure.

Virtual server 1 has assigned CPU 2 as a secondary. The RSM has herein also assigned CPU 4 as a secondary to virtual server 2 as well as to virtual server 3.

In the case when CPU 2 that is shared by virtual server 2 to virtual server 1 has no, or low, load, CPU 2 may execute a task from virtual server 1. However, when virtual server 2 requires more resources, the RSM may reassign CPU 2 back to virtual server 2. Also when virtual server 2 required even compute capacity or processing resources, e.g. at a burst of load, the virtual server 2 may be assigned CPU 4 by the RSM. Virtual server 3 may also have assigned CPU 4, when processing resources are needed by said virtual server. In this very case, by providing resource sharing, the virtual servers can in certain situations behave as if they had seven CPUs, instead of the physical five CPUs.

FIG. 9 presents this case as a continuation of the example presented in FIG. 8, of resource allocation of compute pool, related to embodiments of the present disclosure.

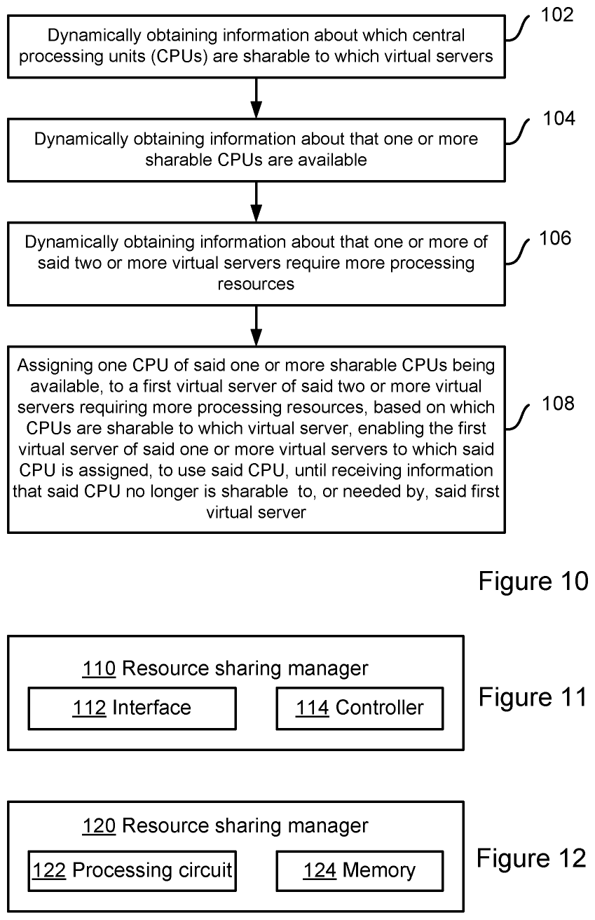

FIG. 10 presents a flow chart of actions in a method of efficient utilization of a plurality of central processing units (CPUs), within two or more virtual servers, according to embodiments of the present disclosure. The method is performed in a resource sharing manager (RSM) that is adapted to manage sharing of said plurality of CPUs within said two or more virtual servers, by interacting with said plurality of CPUs and the two or more virtual servers. The method comprises the following actions:

Action 102: Dynamically obtaining information about which CPUs are sharable to which virtual servers.

Action 102 may also comprise dynamically obtaining information about a sharable status of each CPU. The sharable status is either “sharable or “not sharable”, where “not sharable” equals to “dedicated”.

Action 104: Dynamically obtaining information about that one or more of said sharable CPUs are available.

Action 104 may comprise dynamically obtaining information that one or more of said sharable CPUs have, no or substantially low, workload.

Action 104 of obtaining information about that one or more of said sharable CPUs are available, may comprise monitoring workload of said sharable CPUs and identifying when one or more of said sharable CPUs are candidates for donations.

Action 104 of obtaining information about that one or more of said sharable CPUs are available, may comprise receiving a message from said one or more of said sharable CPUs, registering said one or more of said sharable CPUs as available.

Action 106: Dynamically obtaining information about that one or more virtual servers of said two or more virtual servers require more processing resources.

Action 106 of dynamically obtaining information about that one or more virtual servers of said two or more virtual servers require more processing resources, may comprise monitoring workload of CPUs assigned to said two or more virtual servers and identifying that the workload has increased beyond a workload threshold.

Action 106 of dynamically obtaining information about that one or more virtual servers of said two or more virtual servers require more processing resources, may comprise receiving a message from a CPU assigned to said one or more virtual servers, that the workload of said CPU has increased beyond a workload threshold.

Action 108: Assigning a first CPU of said one or more sharable CPUs being available, to a first virtual server of said one or more virtual servers requiring more resources, based on which CPUs are sharable to which virtual server. Said assigning enables the first virtual server of said one or more virtual servers to which the first CPU is assigned, to use the first CPU, until receiving information, in the method, that the first CPU no longer is sharable to, or needed by, the first virtual server.

Action 108 of assigning a first CPU of said one or more sharable CPUs being available, to a first virtual server of said one or more virtual servers requiring more resources, based on which CPUs are sharable to which virtual server, may comprise assigning the first CPU to the first virtual server of said one or more virtual servers, where the first CPU is owned by a virtual server that is different from the first virtual server.

Action 108 of assigning a first CPU of said one or more sharable CPUs being available, to a first virtual server of said one or more virtual servers requiring more resources, based on which CPUs are sharable to which virtual server, may comprise assigning a first CPU, having no owner, to the first virtual server of said one or more virtual servers.

The present disclosure thus comprises a resource sharing manager (RSM) 60, 70, 110, 120, 414 that is operative to provide efficient utilization of a plurality of central processing units (CPUs), within two or more virtual servers. The RSM 60, 70, 110, 120, 414 is adapted to dynamically obtain information about which CPUs are sharable to which virtual servers, and to dynamically obtain information about that one or more of said sharable CPUs are available. The RSM is also operative to dynamically obtain information about that one or more of said two or more virtual servers require more processing resources. The RSM 60, 70, 110, 120, 414 is further also adapted to assign a first CPU of said one or more sharable CPUs being available, to a first virtual server of said one or more virtual servers requiring more resources, based on which CPUs are sharable to which virtual server, enabling the first virtual server of said one or more virtual servers to which said CPU is assigned, to use the first CPU, until the RSM 60, 70, 110, 120, 414 being adapted to receive information that the first CPU no longer is sharable to, or needed by, the first virtual server, receives such information.

The RSM 60, 70, 110, 120, 414 may further be adapted to obtain information about a sharable status of each CPU. The sharable status may here comprise either “sharable” or “not sharable”, where “not sharable” equals to “dedicated”.

The RSM 60, 70, 110, 120, 414 may be adapted to obtain information that one or more of said sharable CPUs have, no or substantially low, workload.

The RSM 60, 70, 110, 120, 414 may also be adapted to either, monitor workload of said sharable CPUs and identify when one or more of said sharable CPUs are candidates for donations, or to receive a message from said one or more of said sharable CPUs, registering said one or more of said sharable CPUs as available.

The RSM 60, 70, 110, 120, 414 may further be adapted to monitor workload of CPUs assigned to said two or more virtual servers and identify that the workload has increased beyond a workload threshold.

The RSM 60, 70, 110, 120, 414 may also be adapted to receive a message from a CPU assigned to said one or more virtual servers about that the workload of the first CPU has increased beyond a workload threshold.

The RSM 60, 70, 110, 120, 414 may further be adapted to assign the first CPU to said virtual server of said one or more virtual servers, where the first CPU is owned by a virtual server that is different from the first virtual server.

The RSM 60, 70, 110, 120, 414 may also be adapted to assign a first CPU, having no owner, to the first virtual server of said one or more virtual servers.

FIG. 11 presents a resource sharing manager (RSM) 60, 70, 110, 120, 414 that is operative to provide efficient utilization of a plurality of central processing units (CPUs), within two or more virtual servers. The RSM 60, 70, 110, 120, 414 comprises an interface 112 and a controller 114 that is connected to the interface 112.

The interface 112 is adapted to dynamically obtain information about which CPUs are sharable to which virtual servers, and to dynamically obtain information about that one or more of said sharable CPUs are available. The interface 112 is also adapted to dynamically obtain information about that one or more of said two or more virtual servers require more processing resources.

The controller 114 is adapted to assign a first CPU of said one or more sharable CPUs being available, to a first virtual server of said one or more virtual servers requiring more resources, based on which CPUs are sharable to which virtual server, enabling the first virtual server of said one or more virtual servers to which the first CPU is assigned, to use the first CPU, until the RSM 60, 70, 110, 120, 414 being adapted to receive information that the first CPU no longer is sharable to, or needed by, the first virtual server, receives such information.

FIG. 12 presents a resource sharing manager (RSM) 60, 70, 110, 120, 414 that is operative to provide efficient utilization of a plurality of central processing units (CPUs), within two or more virtual servers. The RSM comprises a processing circuit 122 and a memory 124. The memory 124 has instructions being executable by the processing circuit 122, wherein said processing circuit 122, when executing said instructions, is configured to dynamically obtain information about which CPUs are sharable to which virtual servers. The processing circuit 122, when executing said instructions, is configured to dynamically obtain information about that one or more of said sharable CPUs are available. The processing circuit 122, when executing said instructions, is also configured to dynamically obtain information about that one or more of said two or more virtual servers require more processing resources. In addition, the processing circuit 122, when executing said instructions, is also configured to assign a first CPU of said one or more sharable CPUs being available, to a first virtual server of said one or more virtual servers requiring more resources, based on which CPUs are sharable to which virtual server. This enables the first virtual server of said one or more virtual servers to which the first CPU is assigned, to use the first CPU, until the processing circuit 122 that is adapted to receive information that the first CPU no longer is sharable to, or needed by, the first virtual server, receives such information.

The present disclosure also comprises a computer program for providing efficient utilization of a plurality of CPUs. This computer program comprises instructions which, when executed on at least one processor, cause the at least one processor to carry out the actions as presented in the flow-chart of FIG. 10, for efficient utilization of a plurality of CPUs. This disclosure also comprises a computer-readable storage medium having thereon this computer program.

Exemplary embodiments as described herein have the following advantages:

It is advantageous that an improved CPU utilization is achieved by reducing overhead due to passing through extra management layer (hypervisor) when sharing CPUs within different instances or virtual servers.

Virtual servers can have full control over their dynamically allocated resources (CPUs) during the time slot that is given to them, which increase security, and prevent different instances, which could time-share CPU starve or impact each other's performance.

Subsequent to setting up connections between the resource sharing manager and central processing units, communication may be performed directly via an OS, i.e. without having to pass a hypervisor layer, which would else cause an unnecessary latency.

The present disclose enables virtual servers, or instances, to allocate a guaranteed amount of resources, without being charged for all, since resources can be shared when not being used.

It may be further noted that the above described embodiments are only given as examples and should not be limiting to the present exemplary embodiments, since other solutions, uses, objectives, and functions are apparent within the scope of the embodiments as claimed in the accompanying patent claims.

### Abbreviations

CPU central processing unit
DC data center
NIC network interface card
OS operative system
RAM random access memory
VM virtual machine
RSM resource sharing manager

1. A method of efficient utilization of a plurality of central processing units, CPUs, within two or more virtual servers, the method being performed in a resource sharing manager, RSM, being adapted to manage sharing of said plurality of CPUs within said two or more virtual servers, by interacting with said plurality of CPUs and the two or more virtual servers, the method comprising:
dynamically obtaining information about which CPUs are sharable to which virtual servers;
dynamically obtaining information about that one or more of said sharable CPUs are available;
dynamically obtaining information about that one or more virtual servers of said two or more virtual servers require more processing resources; and
dynamically assigning a first CPU of said one or more sharable CPUs being available, to a first virtual server of said one or more virtual servers requiring more resources, based on which CPUs are sharable to which virtual server,
enabling the first virtual server of said one or more virtual servers to which the first CPU is assigned, to use the first CPU, until receiving information that the first CPU no longer is sharable to, or needed by, the first virtual server.

2. The method according to claim 1, wherein dynamically obtaining information about which CPUs are sharable to which virtual servers, further comprises obtaining information about a sharable status of each CPU.

3. The method according to claim 2, wherein the sharable status is either “sharable” or “not sharable”, where “not sharable” equals to “dedicated”.

4. The method according to claim 1, wherein dynamically obtaining information about that one or more of said sharable CPUs are available comprises obtaining information that one or more of said sharable CPUs have, no or substantially low, workload.

5. The method according to claim 1, wherein dynamically obtaining information about that one or more of said sharable CPUs are available, comprises either monitoring workload of said sharable CPUs and identifying when one or more of said sharable CPUs are candidates for donations, or receiving a message from said one or more of said sharable CPUs, registering said one or more of said sharable CPUs as available.

6. The method according to claim 1, wherein dynamically obtaining information about that one or more virtual servers of said two or more virtual servers require more processing resources, comprises monitoring workload of CPUs assigned to said two or more virtual servers and identifying that the workload has increased beyond a workload threshold.

7. The method according to claim 1, wherein dynamically obtaining information about that one or more of said two or more virtual servers require more processing resources, comprises receiving a message from a CPU assigned to said one or more virtual servers, that the workload of said CPU has increased beyond a workload threshold.

8. The method according to claim 1, wherein dynamically assigning a first CPU of said one or more sharable CPUs being available, to a first virtual server of said one or more virtual servers requiring more resources, based on which CPUs are sharable to which virtual server, comprises dynamically assigning the first CPU to the first virtual server of said one or more virtual servers, where the first CPU is owned by a virtual server that is different from the first virtual server.

9. The method according to claim 1, wherein dynamically assigning, the first CPU of said one or more sharable CPUs being available, to one virtual server of said one or more virtual servers requiring more resources, based on which CPUs are sharable to which virtual server, comprises dynamically assigning a first CPU, having no owner, to the first virtual server of said one or more virtual servers.

10. A resource sharing manager, RSM, operative to provide efficient utilization of a plurality of central processing units, CPUs, within two or more virtual servers, the RSM being adapted to dynamically obtain information about which CPUs are sharable to which virtual servers, to dynamically obtain information about that one or more of said sharable CPUs are available, to dynamically obtain information about that one or more of said two or more virtual servers require more processing resources; and to dynamically assign a first CPU of said one or more sharable CPUs being available, to a first virtual server of said one or more virtual servers requiring more resources, based on which CPUs are sharable to which virtual server, enabling the first virtual server of said one or more virtual servers to which said CPU is assigned, to use the first CPU, until the RSM being adapted to receive information that the first CPU no longer is sharable to, or needed by, the first virtual server, receives such information.

11. The RSM according to claim 10, further being adapted to obtain information about a sharable status of each CPU.

12. The RSM according to claim 11, wherein the sharable status comprises either “sharable” or “not sharable”, where “not sharable” equals to “dedicated”.

13. The RSM according to claim 10, further being adapted to dynamically obtain information that one or more of said sharable CPUs have, no or substantially low, workload.

14. The RSM according to claim 10, further being adapted to either monitor workload of said sharable CPUs and identifying when one or more of said sharable CPUs are candidates for donations, or to receive a message from said one or more of said sharable CPUs, registering said one or more of said sharable CPUs as available.

15. The RSM according to claim 10, further being adapted to dynamically monitor workload of CPUs assigned to said two or more virtual servers and identify that the workload has increased beyond a workload threshold.

16. The RSM according to claim 10, further being adapted to dynamically receive a message from a CPU assigned to said one or more virtual servers about that the workload of the first CPU has increased beyond a workload threshold.

17. The RSM according to claim 10, further being adapted to dynamically assign the first CPU to said virtual server of said one or more virtual servers, where the first CPU is owned by a virtual server that is different from the first virtual server.

18. The RSM according to claim 10, further being adapted to dynamically assign a first CPU, having no owner, to the first virtual server of said one or more virtual servers.

19. (canceled)

20. A resource sharing manager, RSM, operative to provide efficient utilization of a plurality of central processing units, CPUs, within two or more virtual servers, the RSM comprising:
a processing circuit; and
a memory having instructions executable by the processing circuit, wherein said processing circuit when executing said instructions is configured to:
dynamically obtain information about which CPUs are sharable to which virtual servers,
dynamically obtain information about that one or more of said sharable CPUs are available,
dynamically obtain information about that one or more of said two or more virtual servers require more processing resources, and
dynamically assign a first CPU of said one or more sharable CPUs being available, to a first virtual server of said one or more virtual servers requiring more resources, based on which CPUs are sharable to which virtual server,
enabling the first virtual server of said one or more virtual servers to which the first CPU is assigned, to use the first CPU, until the processing circuit being adapted to receive information that the first CPU no longer is sharable to, or needed by, the first virtual server, receives such information.

21. (canceled)

22. A computer program product comprising a non-transitory computer-readable storage medium having thereon a computer program for providing efficient utilization of a plurality of central processing units CPUs the computer program comprising instructions which, when executed on at least one processor, cause the at least one processor to carry out the method according to claim 1.
